(19) United States
(12) Patent Application Publication
(10) Pub. No.: US 2026/0332858 A1
(43) Pub. Date: Oct. 22, 2026

(54) METHOD, APPARATUS, DEVICE, COMPUTER READABLE STORAGE MEDIUM AND PRODUCT OF INFORMATION DISPLAY

(71) Applicant: Beijing Zitiao Network Technology Co., Ltd., Beijing (CN)

(72) Inventors: Fujia Liu, Beijing (CN); Xin Li, Beijing (CN)

(21) Appl. No.: 19/112,141

(22) PCT Filed: Sep. 12, 2023
(86) PCT No.: PCT/CN2023/118390

§ 371 Date: Mar. 14, 2025

(30) Foreign Application Priority Data
Sep. 14, 2022 (CN) 202211117284.3

(51) Int. Cl. H04N 21/488; H04N 21/431; H04N 21/442; H04N 21/472; H04N 21/482

(52) U.S. Cl. CPC H04N 21/4882; H04N 21/4312; H04N 21/44204; H04N 21/47217; H04N 21/482

(57) ABSTRACT

Embodiments of the disclosure provides a method, an apparatus, a device, a computer readable storage medium and a product of information display, and the method includes: playing target media content in a media content playback page, to determine playback information corresponding to the target media content; and in response to the playback information satisfying a predetermined display condition, displaying, in the media content playback page, prompt information associated with a poster corresponding to the target media content, the prompt information being used to prompt a first user that the poster posts updated content within a predetermined time interval.

### CROSS REFERENCE

The present disclosure is the U.S. National Stage of International Application No. PCT/CN 2023/118390 filed on Sep. 12, 2023, which claims priority to Chinese Patent No. 202211117284.3, filed on Sep. 14, 2022, and entitled “METHOD, APPARATUS, DEVICE, COMPUTER READABLE STORAGE MEDIUM AND PRODUCT OF INFORMATION DISPLAY”, the entirety of which is incorporated herein by reference.

### FIELD

Embodiments of the present disclosure relates to the technical field of interface interaction, and in particular, to a method, an apparatus, a device, a computer readable storage medium and a product of information display.

### BACKGROUND

In the media content playback page in the short video software, only the target media content currently played, the interaction icon and the head portrait of the poster are displayed.

### SUMMARY

Embodiments of the present disclosure provide a method, an apparatus, a device, a computer readable storage medium and a product of information display.

In a first aspect, embodiments of the present disclosure provide a method of information display, comprising:
playing target media content in a media content playback page, to determine playback information corresponding to the target media content; and in response to the playback information satisfying a predetermined display condition, displaying, in the media content playback page, prompt information associated with a poster corresponding to the target media content, the prompt information being used to prompt a first user that the poster posts updated content within a predetermined time interval.

In a second aspect, embodiments of the present disclosure provide an apparatus for information display, comprising:
a determination module configured to play target media content in a media content playback page, to determine playback information corresponding to the target media content; and
a display module configured to in response to the playback information satisfying a predetermined display condition, display, in the media content playback page, prompt information associated with a poster corresponding to the target media content, the prompt information being used to prompt a first user that the poster posts updated content within a predetermined time interval.

In a third aspect, embodiments of the present disclosure provide an electronic device, comprising: at least one processor and a memory;
the memory storing computer executable instructions;
the at least one processor executing the computer executable instructions stored in the memory, to cause the at least one processor to execute the method of information display according to the first aspect and various possible designs of the first aspect.

In a fourth aspect, embodiments of the present disclosure provide a computer readable storage medium, the computer readable storage medium storing computer executable instructions, when a processor executes the computer executable instructions, implements the method of information display according to the first aspect and various possible designs of the first aspect.

In a fifth aspect, embodiments of the present disclosure provide a computer program product, comprising computer executable instructions, when a processor executes the computer executable instructions, implements the method of information display according to the first aspect and various possible designs of the first aspect.

In a sixth aspect, embodiments of the present disclosure provides a computer program, when a processor executes the computer program, implements the method of information display according to the first aspect and various possible designs of the first aspect.

### BRIEF DESCRIPTION OF DRAWINGS

In order to more clearly illustrate embodiments of the present disclosure or the technical solutions in the existing technology, the accompanying drawings need to be used in the description of embodiments or the existing technology will be briefly introduced below, and it will be apparent that the drawings in the following descriptions are some embodiments of the present disclosure, and those skilled in the art may also obtain other drawings according to these drawings without creative labor.

FIG. 1 is a schematic flowchart of a method of information display provided by embodiments of the present disclosure;

FIG. 2 is a schematic diagram of interface interaction provided by embodiments of the present disclosure;

FIG. 3 is a schematic flowchart of a method of information display provided by another embodiment of the present disclosure;

FIG. 4 is a schematic diagram of another interface interaction provided by embodiments of the present disclosure;

FIG. 5 is a schematic diagram of another interface interaction provided by embodiments of the present disclosure;

FIG. 6A is a schematic diagram of a display interface provided by embodiments of the present disclosure;

FIG. 6B is a schematic diagram of another display interface provided by embodiments of the present disclosure;

FIG. 6C is a schematic diagram of another display interface provided by embodiments of the present disclosure;

FIG. 7 is a schematic flowchart of a method of information display provided by another embodiment of the present disclosure;

FIG. 8 is a schematic diagram of interface interaction provided by embodiments of the present disclosure;

FIG. 9A is a schematic diagram of another interface interaction provided by embodiments of the present disclosure;

FIG. 9B is a schematic diagram of another interface interaction provided by embodiments of the present disclosure;

FIG. 10 is a schematic diagram of interface interaction provided by another embodiment of the present disclosure;

FIG. 11 is a schematic diagram of a structure of an apparatus for information display provided by another embodiment of the present disclosure; and

FIG. 12 is a schematic diagram of a structure of an electronic device provided by embodiments of the present disclosure.

### DETAILED DESCRIPTION

In order to make the objectives, technical solutions and advantages of embodiments of the present disclosure clearer, the technical solutions in embodiments of the present disclosure will be clearly and completely described below with reference to the accompanying drawings in embodiments of the present disclosure. Obviously, embodiments described are a part of embodiments of the present disclosure, rather than all embodiments. Based on embodiments of the present disclosure, all other embodiments obtained by those skilled in the art without creative labor belong to the protection scope of the present disclosure.

The display content in the media content playback page is relatively single, and if the user further wants to obtain more content in the media content playback page, more interface switching operations are required, resulting in poor efficiency of the interaction. In order to solve the technical problem that display content in an existing media content playback page is relatively single, the present disclosure provides a method, an apparatus, a device, a computer readable storage medium and a product of information display, to determine playback information corresponding to the target media content by playing target media content in a media content playback page. When it is detected that the playback information satisfies a predetermined display condition, prompt information associated with a poster corresponding to the target media content is displayed in the media content playback page. Thereby, according to the prompt information, the user can determine that the poster posts the updated content within the predetermined time interval. Furthermore, more content can be presented in the media content playback page according to the playback information of the target media content, and the operation efficiency is improved.

It should be noted that the method, apparatus, device, computer readable storage medium and product of information display provided by the present disclosure may be applied to any scenario of content presentation of content presentation page.

The existing media content presentation page generally only displays the media content and the identification information of the poster that posts the media content. The user may not obtain more display content in the media content presentation page. The process of browsing the media content is caused to be boring for the user, and the media content which the user more interested to may be missed.

In order to enable the first user to obtain more display content in the media content presentation page, the playback information corresponding to the target media content may be determined in the process of playing the target media content. The playback information includes but is not limited to at least one of: a playback progress corresponding to the target media content, loop playback times corresponding to the target media content, or an association relationship between the poster of the target media content and the first user. Therefore, when the playback information satisfies a predetermined display condition, the prompt information associated with the poster corresponding to the target media content may be displayed in the media content playback page, so that the first user may determine, according to the prompt information, that the poster posts updated content within the predetermined time interval.

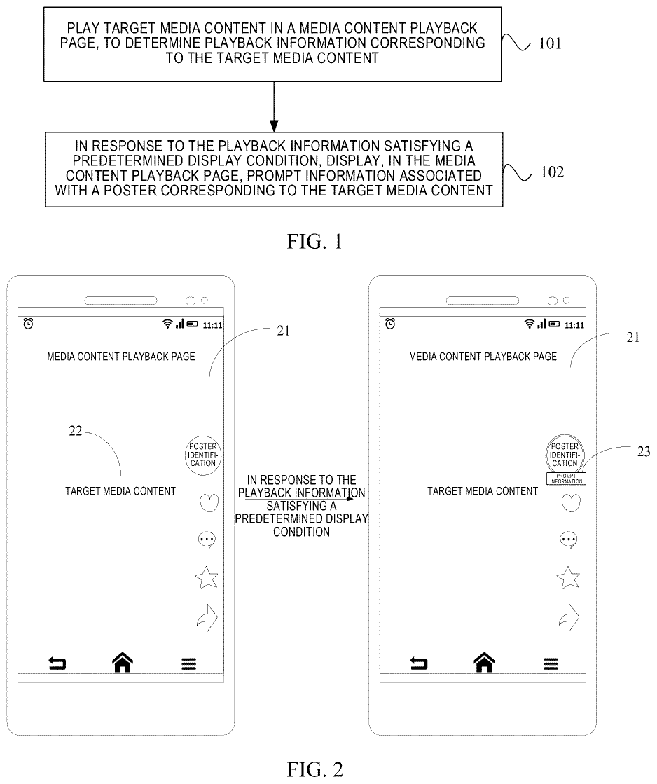

FIG. 1 is a schematic flowchart of a method of information display provided by embodiments of the present disclosure. As shown in FIG. 1, the method includes:
Step 101: play target media content in a media content playback page, to determine playback information corresponding to the target media content.

The executing body of this embodiment is an apparatus for information display, and the apparatus for information display may be coupled to the terminal device, so that the playback information may be determined in the playback process of the target media content, and the prompt information may be displayed according to the playback information. Optionally, the apparatus for information display may also be coupled to a server, and the server may be communicatively connected to the terminal device, thereby playback information corresponding to the target media content in the terminal device may be determined, and the prompt information may be displayed according to the playback information.

In this embodiment, the media content may be played in the media content playback page, and the first user may watch the media content in the media content playback page according to actual requirements. The media content includes, but is not limited to, video media content, text media content, image media content, and the like.

When the target media content is played in the media content playback page, the playback information corresponding to the target media content may be determined.

Optionally, a predetermined association relationship may exist between the poster of the target media content and the first user. For example, the target media content may be media content posted by a user that the first user follows, or the target media content may be media content posted by a poster that the first user follows with each other.

Optionally, a predetermined association relationship may also not exist between the poster of the target media content and the first user.

The playback information includes at least one of: a playback progress, loop playback times, or an association relationship between the poster of the target media content and the first user.
Step 102: in response to the playback information satisfying a predetermined display condition, displaying, in the media content playback page, prompt information associated with a poster corresponding to the target media content.

In this embodiment, in order to enrich the display content in the media content playback page, prompt information may be displayed in the media content playback page. The prompt information is used to prompt the first user that the poster posts the updated content within a predetermined time interval. The prompt information may include different display content, for example, the prompt information may be 2 updates, 99 updates, updates within one day, updates within 2 hours, or the like. Optionally, different display contents may be displayed for different application scenarios. Alternatively, the first user may also adjust the display content according to actual requirements, which is not limited in the present disclosure. For example, the updated content includes an updated video, a new commodity, an updated discount activity, an updated group purchase information, and the like. Different updated content may corresponds to displaying different types of prompt information.

Further, a display condition may be predetermined, and when it is detected that the playback information satisfies the predetermined display condition, prompt information associated with the poster corresponding to the target media content may be displayed in the media content playback page.

Optionally, in order to enable the display of the prompt information to be adapted to different application scenarios, the amount of display conditions may be a plurality of, and when it is detected that the playback information satisfies any one of the display conditions, the prompt information may be displayed in the media content playback page.

Therefore, the first user can more intuitively determine the related information of the updated content posted by the poster posts within the predetermined time interval according to the prompt information in the media content playback page. The related information of the updated content includes, but is not limited to, the amount of updated content posted by the poster within a predetermined time interval; the amount of updated content that is not watched by the first user in the updated content posted by the poster in a predetermined time interval; an update of the poster exists within a predetermined time interval.

FIG. 2 is a schematic diagram of interface interaction provided by embodiments of the present disclosure. As shown in FIG. 2, the target media content 22 may be played in the media content playback page 21 according to the triggering operation of the first user, and when it is detected that the playback information satisfies the predetermined display condition, prompt information 23 associated with the poster corresponding to the target media content is displayed in the media content playback page 21.

Optionally, when the prompt information is displayed for the first time, a triggering reminder may be displayed in a predetermined range around the prompt information, to remind the user to achieve viewing the updated content by triggering the prompt information. For example, the guidance information may be displayed at the prompt information, and the guidance information may be: click to view the updated content. Therefore, the user may be able to know the function of the prompt information.

Further, based on any one of the above embodiments, step 101 includes: determining at least one of: a playback progress corresponding to the target media content, loop playback times corresponding to the target media content, or an association relationship between the poster of the target media content and the first user.
obtaining the playback information based on at least one of: the playback progress corresponding to the target media content, the loop playback times corresponding to the target media content, or the association relationship between the poster of the target media content and the first user.

In this embodiment, to achieve obtaining the playback information, at least one of: a playback progress corresponding to the target media content, loop playback times corresponding to the target media content, or an association relationship between the poster of the target media content and the first user may be determined. Based on at least one of: the playback progress corresponding to the target media content, the loop playback times corresponding to the target media content, or the association relationship between the poster of the target media content and the first user, the playback information may be obtained.

The method of information display provided in this embodiment includes in response to playing target media content in a media content playback page, determining playback information corresponding to the target media content; and in response to the playback information satisfying a predetermined display condition, displaying, in the media content playback page, prompt information associated with a poster corresponding to the target media content. Therefore, the user can determine, according to the prompt information, that the poster posts the updated content within a predetermined time interval. Furthermore, the display content in the media content playback page can be enriched according to the prompt information.

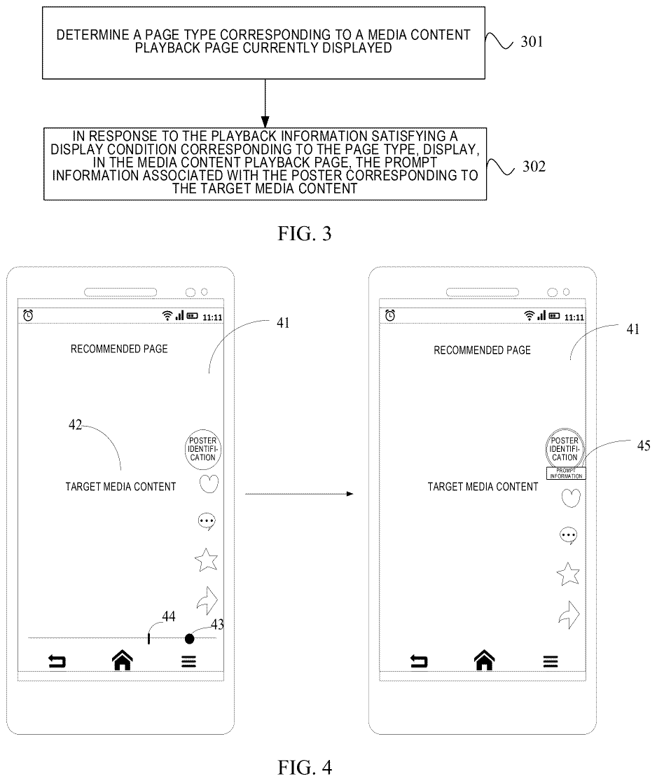

FIG. 3 is a schematic flowchart of a method of information display provided by another embodiment of the present disclosure. As shown in FIG. 3, based on any of the foregoing embodiments, step 102 includes:
Step 301: determine a page type corresponding to a media content playback page currently displayed.
Step 302: in response to the playback information satisfying a display condition corresponding to the page type, display, in the media content playback page, the prompt information associated with the poster corresponding to the target media content.

In this embodiment, the media content playback page corresponds to different page types. As an example, different page types may include different media content stream playback pages, or media content search result pages. Specifically, the media content playback page may include a first page type, and in the media content playback page of the first type, a recommended media content stream may be played. A part of posters of media content in the recommended media content stream have an association relationship with the first user, and a part of posters do not have an association relationship with the first user.

The media content playback page may further include a second page type, and media content posted by a poster having a predetermined association relationship with the first user may be played in the media content playback page of the second page type. For example, the media content posted by the poster followed by the first user is played in the media content playback page of the second page type.

It is understood that, based on the relationship between the first user and the poster, the degree of interest of the poster of the target media content played in the media content playback pages of different page types for the first user is different. Therefore, different display conditions may be set for the media content playback pages of different page types.

Further, after obtaining the playback information corresponding to the target media content, the page type corresponding to the media content playback page currently displayed may be determined. The display condition corresponding to the page type is determined. When it is detected that the play information satisfies the display condition corresponding to the page type, prompt information associated with the poster corresponding to the target media content is displayed in the media content play page.

Further, based on any one of the above embodiments, the media content playback page is a first page type. As an example, the media content playback page of the first page type is used to play the recommended media content stream. The playback information includes a playback progress corresponding to the target media content. Step 302 includes:
in response to detecting that the playback progress corresponding to the target media content exceeds a predetermined playback progress threshold, displaying, in the media content playback page, the prompt information associated with the poster corresponding to the target media content.

The prompt information includes amount of updated content posted by a poster within a first predetermined time interval.

In this embodiment, the media content playback page may include a first page type, and the media content playback page corresponding to the first page type may be specifically configured to play the recommended media content stream.

In the media content playback page corresponding to the first page type, a playback progress threshold may be predetermined, where the playback threshold may be 80%, 90%, or the playback progress threshold may be set by the first user according to actual requirements, which is not limited in the present disclosure.

Optionally, the playback information includes a playback progress corresponding to the target media content. The apparatus for information display may obtain the playback progress corresponding to the target media content in real time, and if it is detected that the playback progress exceeds the predetermined playback progress threshold, then it represents that the first user is more interested in the target media content, or may represent that the first user is more interested in media content posted by the poster of the target media content. In order to optimize the browsing experience of the first user, to enable the first user to browse more media content interested in, prompt information associated with the poster corresponding to the target media content may be displayed in the media content playback page.

The prompt information includes amount of updated content posted by a poster within a first predetermined time interval. As an example, the first predetermined time interval may be three days. The prompt information may be a sum of updated content posted by posters within three days. Alternatively, the prompt information may be a sum of updated content that is not watched by the first user in the updated content posted by the poster within three days. Alternatively, the prompt information may be existing updates by the poster within three days. The display form of the prompt information is not limited in the present disclosure.

FIG. 4 is a schematic diagram of another interface interaction provided by embodiments of the present disclosure. As shown in FIG. 4, the media content playback page may be a recommended page, the target media content 42 may be played in the recommended page 41 according to the triggering operation of the first user, and when it is detected that the playback progress 43 corresponding to the target media content 42 exceeds the predetermined playback progress threshold 44, prompt information 45 associated with the poster corresponding to the target media content may be displayed in the recommended page 41.

According to the method of information display provided by the embodiment, the prompt information is displayed in the media content playback page of the first page type when the playback progress corresponding to the target media content is detected to exceed the predetermined playback progress threshold. Therefore, the display content in the media content playback page can be enriched, to enable the user to browse more content in the media content playback page, and the interaction efficiency is improved.

Further, based on any one of the foregoing embodiments, the media content playback page is a second page type, and the media content playback page of the second page type is used to play media content posted by at least one second user having a predetermined association relationship with the first user. The play information includes loop playback times corresponding to the target media content.

Step 302 includes:
in response to detecting that the loop playback times corresponding to the target media content exceeds a predetermined playback times threshold, displaying, in the media content playback page, the prompt information associated with the poster corresponding to the target media content. the prompt information comprises amount of updated content posted by a poster within a second predetermined time interval.

In this embodiment, the media content playback page may be a second page type. The media content posted by the at least one second user having the predetermined association relationship with the first user may be played in the media content playback page of the second page type. When the media content playback page is the second page type, the playback information may include loop playback times corresponding to the target media content.

Optionally, in order to achieve the display of the prompt information, a playback times threshold may be predetermined. The playback times threshold may be 1 time, or may be times set by the first user according to actual requirements, which is not limited in the present disclosure.

After obtaining the loop playback times corresponding to the target media content, it may be detected whether the loop playback times corresponding to the target media content is greater than a predetermined playback times threshold. If the loop playback times corresponding to the target media content is greater than a predetermined playback times threshold, it represents that the first user is more interested in the target media content, or may represent that the first user is more interested in the media content posted by the second user. Therefore, in order to enable the first user to know the updated content posted by the second user, prompt information associated with the poster corresponding to the target media content may be displayed in the media content playback page.

The prompt information includes amount of updated content posted by a poster within a second predetermined time interval. As an example, since a predetermined association relationship between the first user and the second user exists, and the first user is more interested in the target media content posted by the second user, the second predetermined time interval may be seven days. The prompt information may be a sum of updated content posted by posters within seven days. Alternatively, the prompt information may be a sum of updated content that is not watched by the first user in the updated content posted by the poster within seven days. Alternatively, the prompt information may be existing updates by the poster within seven days. The display form of the prompt information is not limited in the present disclosure.

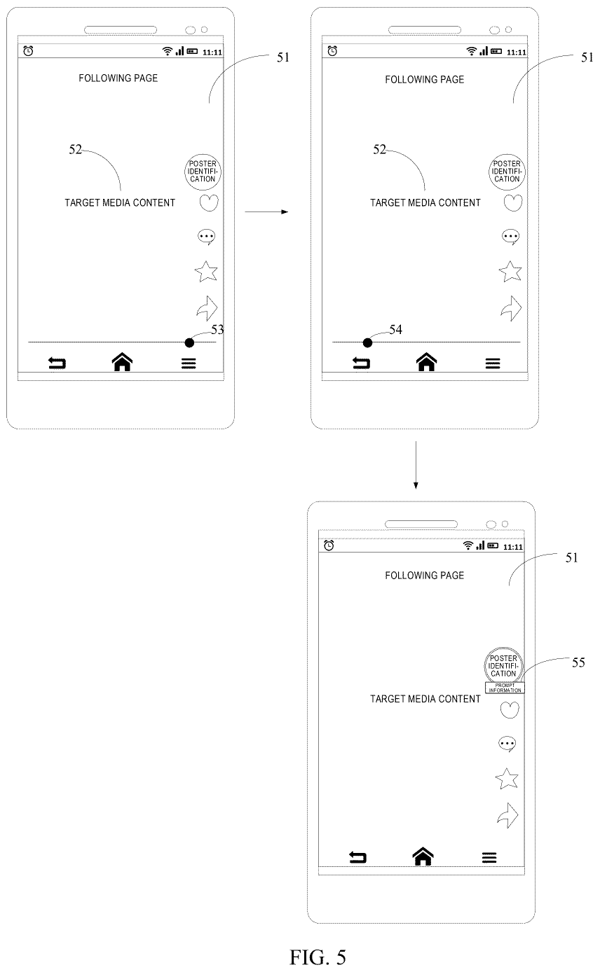

FIG. 5 is a schematic diagram of another interface interaction provided by embodiments of the present disclosure. As shown in FIG. 5, the media content playback page may a following page. As an example, the predetermined playback times threshold may be one time. The target media content 52 may be played in the following page 51 according to the triggering operation of the first user, and when it is detected that the target media content 52 is played completely 53, it starts to be played again from the head 54, which represents that when the loop playback times corresponding to the target media content 52 exceeds a predetermined playback time thresholds, prompt information 55 associated with the poster corresponding to the target media content 52 may be displayed in the following page 51.

According to the method of information display provided in this embodiment, when the media content playback page is the second page type, if it is detected that the loop playback times corresponding to the target media content exceeds the predetermined playback times threshold, the prompt information is displayed. Therefore, the display content of the media content playback page can be enriched, to enable the user to more intuitively obtain the updated content of the poster in the media content playback page. The operation flow of viewing updated content is simplified.

Further, based on any one of the foregoing embodiments, the playback information includes an association relationship between a poster of the target media content and a first user. Step 102 includes: in response to detecting that the association relationship between the poster and the first user is any of at least one predetermined type of target association relationship, displaying, in the media content playback page, the prompt information associated with the poster corresponding to the target media content.

In this embodiment, an association relationship may exist between the first user and the poster, for example, the first user and the poster may be friends who follows with to each other, or the first user may follow the poster, or the first user may set a predetermined identification for the poster, where the predetermined identification includes, but is not limited to, a set-top identification, a special following identification, and the like, or the first user may be hardcore fan who frequently browses media content posted by the poster, and the like.

If any of the foregoing target association relationship exists between the first user and the poster, then it represents that the first user is more interested in the updated content posted by the poster. Therefore, the association relationship between the poster and the first user may be determined, and when it is detected that the association relationship is any of the at least one predetermined type of target association relationship, prompt information associated with the poster corresponding to the target media content is displayed in the media content playback page.

Further, based on any one of the foregoing embodiments, when it is detected that the association relationship between the poster and the first user is any of the at least one predetermined type of target association relationship, displaying the prompt information associated with the poster corresponding to the target media content in the media content playback page includes:
in response to detecting that the association relationship between the poster and the first user is a predetermined first target association relationship, displaying, in the media content playback page, the prompt information associated with the poster corresponding to the target media content.
The first target association relationship is used to represent that an accumulated duration of the first user watching media content posted by the poster exceeds a predetermined duration and/or an accumulated number of times of the first user watching media content posted by the poster exceeds a predetermined number of times.
the prompt information comprises amount of updated content posted by a poster within a third predetermined time interval, and/or the prompt information comprises a prompt that the poster has updated content within a fourth predetermined time interval.

In this embodiment, the association relationship between the poster and the first user may be a predetermined first target association relationship. The first target association relationship is used to represent that an accumulated duration of the first user watching media content posted by the poster exceeds a predetermined duration and/or an accumulated number of times of the first user watching media content posted by the poster exceeds a predetermined number of times. That is, the first user is more interested in one or more media content posted by the poster.

Therefore, when it is detected that the association relationship between the poster and the first user is the predetermined first target association relationship, prompt information associated with the poster corresponding to the target media content may be directly displayed in the media content playback page.

The prompt information includes amount of updated content posted by a poster within a third predetermined time interval, and/or the prompt information includes a prompt that the poster has updated content within a fourth predetermined time interval.

As an example, the third predetermined time interval may be seven days, and the prompt information may be total amount of updated content posted by the poster within 7 days. The fourth predetermined time interval may be one day, and the prompt information may be having updates within one day.

According to the method of information display provided in this embodiment, when it is detected that the association relationship between the poster and the first user is the predetermined first target association relationship, the prompt information associated with the poster corresponding to the target media content is displayed in the media content playback page, to enable the first user to know that the poster posts the updated content within the predetermined time interval when the first user watching the target media content.

Further, based on any one of the foregoing embodiments, when it is detected that the association relationship between the poster and the first user is any of the predetermined target association relationships, displaying the prompt information associated with the poster corresponding to the target media content in the media content playback page includes:
in response to detecting that the association relationship between the poster and the first user is a predetermined second target association relationship, displaying a predetermined identification and/or a predetermined animation at an identification of the poster in the media content playback page.
the second target association relationship is used to represent that the poster is a user for whom the first user sets the predetermined identification or the first user and the poster satisfy a predetermined association relationship with each other.

In this embodiment, the association relationship between the poster and the first user may be a predetermined second target association relationship. The second target association relationship is used to represent that the poster is a user for whom the first user sets the predetermined identification or the first user and the poster satisfy a predetermined association relationship with each other.

For example, the second target association relationship may be that the first user sets a set-top identification or a special following identification or an update prompting identification for the poster. Optionally, the second target association relationship may also be an association relationship that the first user and the poster follow each other.

When it is detected that the association relationship between the poster and the first user is the predetermined second target association relationship, to enhance the display effect of the prompt information, the predetermined identification and/or the predetermined animation may be displayed at the identification of the poster in the media content playback page. The predetermined identification may be a display identification corresponding to the association relationship, and the predetermined animation may be a breathing animation.

According to the method of information display provided by the embodiment, when it is detected that the association relationship between the poster and the first user is the predetermined second target association relationship, the predetermined identification and/or the predetermined animation is displayed, to enable the user to more intuitively know the updated content posted by the poster in time based on enriching the display content in the media content playback page.

Further, based on any one of the foregoing embodiments, displaying prompt information associated with a poster corresponding to the target media content in the media content playback page includes: displaying the prompt information at an association location corresponding to an identification of the poster in the media content playback page.

In this embodiment, in order to enable the first user to more intuitively know the updated content posted by the poster, prompt information may be displayed at the association location corresponding to the identification of the poster in the media content playback page. The association location may be at a predetermined region around the identification of the poster. The identification of the poster may be an avatar identification of the poster, or may be a name identification of the poster, which is not limited in the present disclosure.

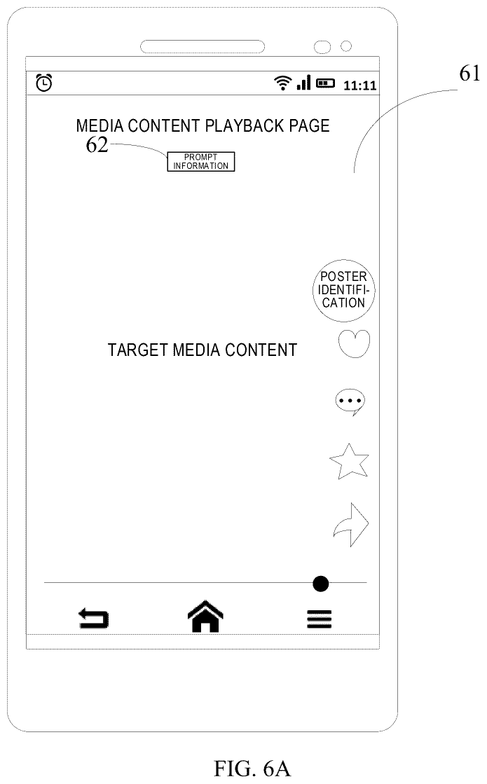

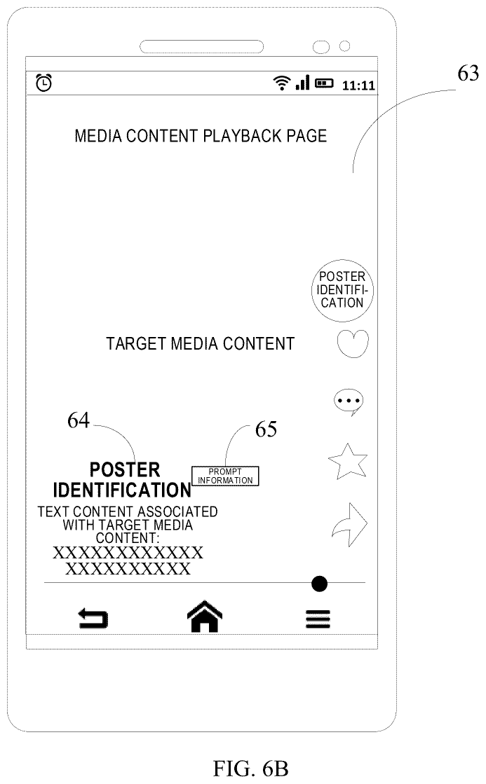

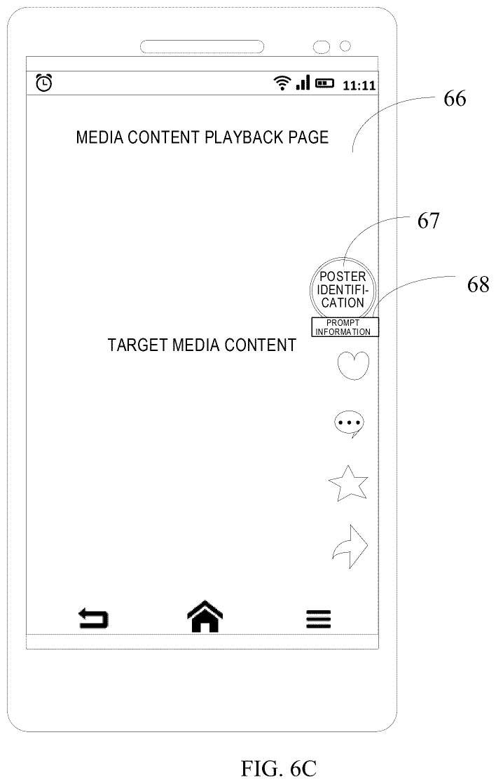

FIG. 6A is a schematic diagram of a display interface provided by embodiments of the present disclosure. As shown in FIG. 6A, in order to enrich the display content of the media content playback page, the prompt information 62 may be displayed on the top of the media content playback page 61 in a manner of pop-window. Alternatively, FIG. 6B is a schematic diagram of another display interface provided by embodiments of the present disclosure. As shown in FIG. 6B, the prompt information 65 may be displayed in a predetermined region around the poster identification 64 corresponding to the target media content in the media content playback page 63, where the poster identification may be a name of the poster. Alternatively, FIG. 6C is a schematic diagram of another display interface provided by embodiments of the present disclosure. As shown in FIG. 6C, prompt information 68 may be displayed at an association location corresponding to a poster identification 67 in a media content playback page 66, where the poster identification may be an avatar of a poster.

According to method of information display provided by the embodiment, the prompt information is displayed at the association position corresponding to the identification of the poster in the media content playback page. Therefore, the correlation degree between the prompt information and the poster can be improved, to enable the first user to more intuitively know the updated content posted by the poster in the predetermined time interval, and the interaction efficiency is improved.

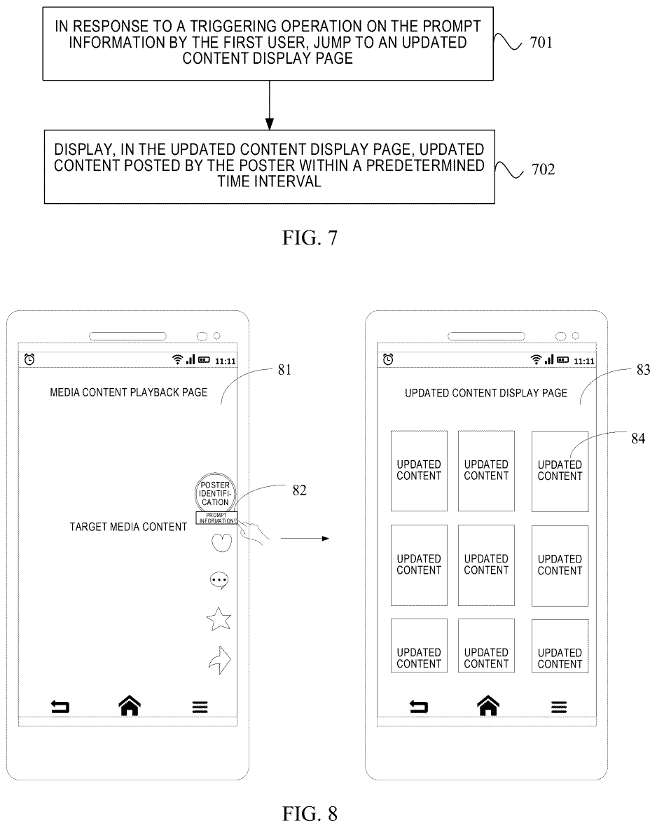

FIG. 7 is a schematic flowchart of a method of information display provided by another embodiment of the present disclosure. Based on any of the foregoing embodiments, as shown in FIG. 7, after step 102, further including:
Step 701: in response to a triggering operation on the prompt information by the first user, switch to an updated content display page.
Step 702: display, in the updated content display page, updated content posted by the poster within a predetermined time interval.

In this embodiment, the first user may perform the triggering operation on the prompt information according to an actual requirement to achieve viewing the updated content. Optionally, in response to the triggering operation on the prompt information by the first user, the updated content display page may be switched to. The triggering operation includes, but is not limited to, a triggering manner such as single-clicking, double-clicking, long-pressing, and dragging.

After switching to the updated content display page, the updated content posted by the poster within the predetermined time interval may be displayed in the updated content display page. Therefore, the first user can select the updated content of interest for viewing according to actual requirements.

FIG. 8 is a schematic diagram of interface interaction provided by embodiments of the present disclosure. As shown in FIG. 8, prompt information 82 may be displayed on the media content playback page 81. The first user may trigger the prompt information 82 according to actual requirements. In response to triggering operation on the prompt information 82 by the user, the update content display page 83 may be switched to, where the update content display page 83 includes the update content 84 posted by a plurality of posters within a predetermined time interval.

According to the method of information display provided by this embodiment, the updated content display page is switched to in response to the triggering operation on the prompt information by the first user, thereby simplifying the process of viewing the update content. Updated content posted by posters can be viewed more quickly.

Further, based on any one of the foregoing embodiments, step 701 includes:
determining an association identification corresponding to the prompt information.
jumping to an updated content display page corresponding to the association identification based on the association identification.

In this embodiment, updated content includes updated media content or updated resource content. The updated media content includes, but is not limited to, updated video media content, updated image media content, updated audio media content, and updated the text media content. Updated resource content includes, but is not limited to, a new commodity, an updated discount activity, updated group-buying information, and the like.

In order to enable display of different updated content to be achieved accurately, the prompt information also corresponds to an association identification. Therefore, after the prompt information is displayed in the media content playback page, the association identification corresponding to the prompt information may also be determined. The updated content display page corresponding to the association identification is determined, and the updated content display page corresponding to the association identification is switched to. Different updated content may be displayed in different updated content display pages.

According to the method of information display by the embodiment, different updated content display pages are switched to according to different association identifications. Therefore, the display of different types of updated content can be accurately achieved, and the display effect of the updated content is enriched.

Further, based on any one of the foregoing embodiments, the association identification includes the type of the poster.

Jumping to an updated content display page corresponding to the association identification based on the association identification includes:
in response to the type of the poster being a first type, switching to a first updated content display page based on the association identification, the first updated content display page being used to display updated media content posted by the poster within a predetermined time interval.
in response to the type of the poster being a second type, switching to a second updated content display page based on the association identification, the second updated content display page being used to display updated resource content posted by the poster within a predetermined time interval.

In this embodiment, the association identification may specifically be a type of the poster. The type of the poster may include a first type and a second type. When the type of the poster is the first type, it represents that the updated content posted by the poster is the updated media content. The updated media content includes, but is not limited to, updated video media content, updated image media content, updated audio media content, and updated text media content. Therefore, when the type of the poster is the first type, in response to the triggering operation on the prompt information by the first user, the first updated content display page may be switched to. The first updated content display page displays updated media content posted by the poster within a predetermined time interval. Therefore, the first user may select the updated media content of interest from the first updated content display page for viewing according to actual requirements.

When the type of the poster is the second type, it represents that the updated content posted by the poster is the updated resource content. The updated resource content includes, but is not limited to, a new commodity, an updated discount activity, an updated group-buying information, and the like. Therefore, when the type of the poster is the second type, in response to the triggering operation on the prompt information by the first user, the second updated content display page may be switched to. The second updated content display page displays updated resource content posted by the poster within a predetermined time interval. Therefore, the first user may select the updated resource content of interest from the second updated content display page for viewing according to the actual requirement. It may be understood that the updated content posted by the poster may provide the updated content posted by the object for the commodity associated with the posting account.

According to the method of information display provided by this embodiment, by switching to different updated content display pages according to different poster types, the display of the updated content can be accurately performed according to the poster type, to enable the first user to achieve the view of different types of updated content according to the prompt information.

Further, based on any one of the foregoing embodiments, the association identification includes an update type.

Jumping to an updated content display page corresponding to the association identification based on the association identification includes:
in response to the update type being a media content update type, switching to a first updated content display page based on the association identification, the first updated content display page being used to display updated media content posted by the poster within a predetermined time interval.
in response to the update type being a resource content update type, switching to a second updated content display page based on the association identification, the second updated content display page being used to display updated resource content posted by the poster within a predetermined time interval.

In this embodiment, the association identification may specifically be an update type. The update type includes a media content update type. When the update type is the media content update type, it represents that the updated content posted by the poster is the updated media content. The updated media content includes, but is not limited to, updated video media content, updated image media content, updated audio media content, and updated text media content. Therefore, when the update type is the media content update type, the first updated content display page may be switched to in response to the triggering operation on the prompt information by the first user. The first updated content display page displays updated media content posted by the poster within a predetermined time interval. Therefore, the first user may select the updated media content of interest from the first updated content display page for viewing according to actual requirements.

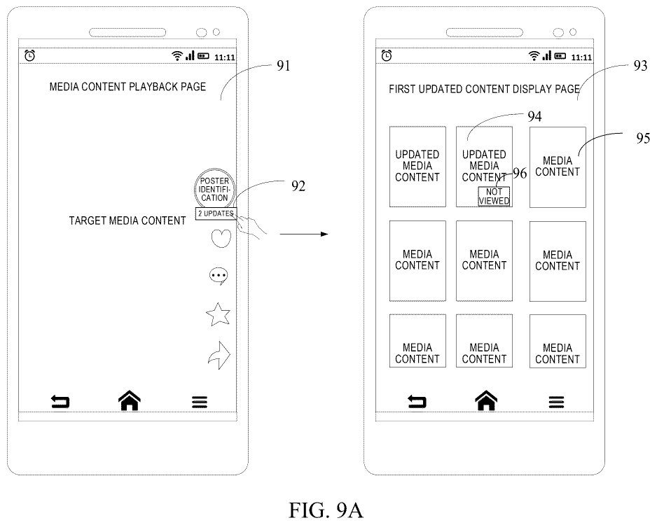

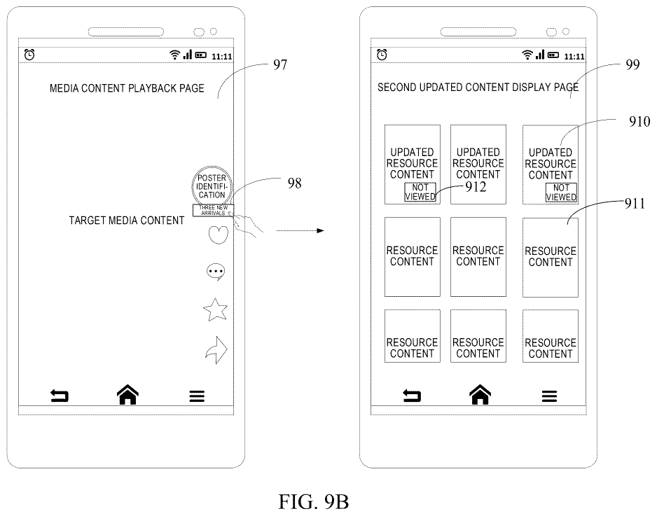

FIG. 9A is a schematic diagram of another interface interaction provided by embodiments of the present disclosure. As shown in FIG. 9A, when the update type is a media content update type, a first association identification 92 corresponding to the prompt information may be displayed in the media content playback page 91, where the first association identification 92 may be 2 updates. In response to the triggering operation on the prompt information by the first user, the first updated content display page 93 may be switched to, where the first updated content display page 93 includes two update media content 94 posted by the poster within a predetermined time interval, and a plurality of media content 95 posted by the poster before the predetermined time interval. Optionally, an update identification is further displayed on the update media content 94. As an example, the update identification on the unviewed updated media content may specifically be the unviewed identification 96. The unviewed identification 96 is specifically used to represent a browsing situation of the update media content 94 by the first user. If the update media content 94 is not browsed by the first user, then the unviewed identification 96 is displayed on the update media content 94. If the update media content 94 is browsed by the first user (e.g., for a work browsed on the media content playback page 91), then the unviewed identification 96 may not be displayed on the update media content 94. Alternatively, if the first user has completed browsing the update media content 94, then the already read identification may be displayed on the update media content 94.

Optionally, the update type further includes a resource content update type. When the update type is the resource content update type, it represents that the updated content posted by the poster is the updated resource content. The updated resource content includes, but is not limited to, a new commodity, an updated discount activity, an updated group-buying information, and the like. Therefore, when the update type is the resource content update type, the second updated content display page may be switched to in response to the triggering operation on the prompt information by the first user. The second updated content display page displays updated resource content posted by the poster within a predetermined time interval. Therefore, the first user may select the updated resource content of interest from the second updated content display page for viewing according to the actual requirement.

FIG. 9B is a schematic diagram of another interface interaction provided by embodiments of the present disclosure. As shown in FIG. 9B, when the update type is a resource content update type, a second association identification 98 corresponding to the prompt information may be displayed in the media content playback page 97, where the second association identification 98 may be three new arrivals. In response to the triggering operation on the prompt information by the first user, the second updated content display page 99 may be switched to, where the second updated content display page 99 may display three updated resource contents 910 posted by the poster in a predetermined time interval, and a plurality of resource contents 911 posted by the poster before the predetermined time interval. Optionally, an update identification is further displayed on the updated resource content 910. As an example, the update identification on the unviewed updated media content may be the unviewed identification 912. For the updated resource content 910 displayed in the second updated content display page 99, if the updated resource content 910 is not browsed by the first user, then the unviewed identification 912 may be displayed on the updated resource content 910. If the first user has completed browsing the updated resource content 910, the updated resource content 910 may not display the unviewed identification 912 or display the already read identification.

According to the method of information display provided by this embodiment, the display effect of the updated content can be enriched by switching to different updated content display pages according to different update types, to enable the first user to achieve viewing different types of updated content by the prompt information. The viewing flow of different types of updated content is simplified, and interaction efficiency is improved.

Further, based on any one of the foregoing embodiments, step 702 includes: displaying, in the updated content display page, an updated content stream corresponding to updated content posted by the poster within the predetermined time interval.

In this embodiment, the updated content stream corresponding to the updated content posted by the poster within the predetermined time interval may be displayed in the updated content display page. The updated content stream includes updated content posted by the poster within a predetermined time interval. The first user may trigger the switching operation according to the actual requirement, to achieve the switching operation of updated content in the updated content stream, and the operation flow of viewing updated content is simplified.

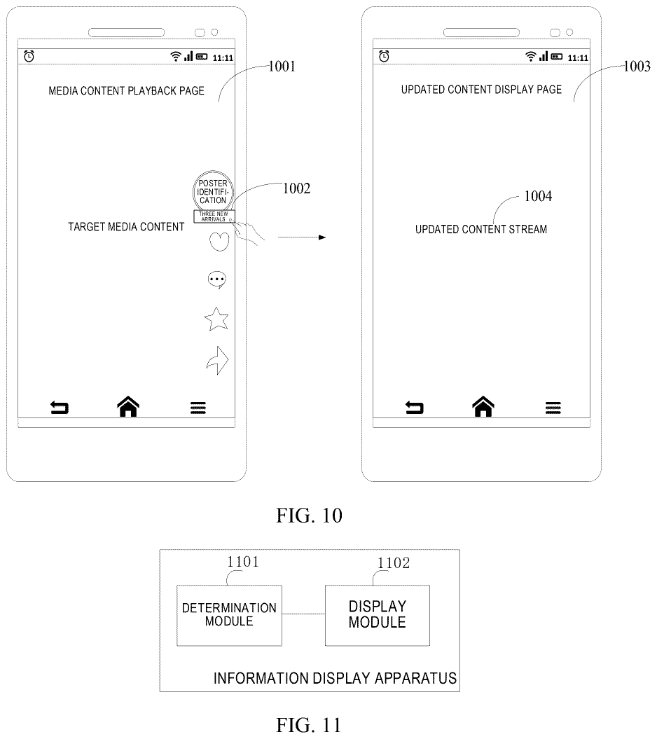

FIG. 10 is a schematic diagram of interface interaction provided by another embodiment of the present disclosure. As shown in FIG. 10, prompt information 1002 may be displayed on the media content playback page 1001. The first user may trigger the prompt information 1002 according to actual requirements. In response to the triggering operation on the prompt information 1002 by the user, the updated content display page 1003 may be switched to, where the updated content stream 1004 may be displayed in the updated content display page 1003. In response to switching operation on the updated content stream 1004 by the user, other updated content in the updated content stream 1004 may be displayed.

According to the method of information display provided by the embodiment, the updated content stream corresponding to the updated content is displayed in response to the triggering operation on the prompt information by the first user. Therefore, the first user can achieve the switch of different updated content by a simple swiping operation, and the operation flow of viewing updated content view is simplified, which enables the first user to quickly and conveniently achieve viewing a plurality of updated content, and the interaction efficiency is improved.

FIG. 11 is a schematic diagram of a structure of an apparatus for information display provided by another embodiment of the present disclosure. As shown in FIG. 11, the apparatus includes: a determination module 1101 and a display module 1102. The determination module 1101 is configured to play target media content in a media content playback page, to determine playback information corresponding to the target media content. The display module 1102 is configured to in response to the playback information satisfying a predetermined display condition, display, in the media content playback page, prompt information associated with a poster corresponding to the target media content, the prompt information being used to prompt a first user that the poster posts updated content within a predetermined time interval.

Further, based on any one of the foregoing embodiments, the determination module is further configured to: determine at least one of: a playback progress corresponding to the target media content, loop playback times corresponding to the target media content, or an association relationship between the poster of the target media content and the first user; and obtain the playback information based on at least one of: the playback progress corresponding to the target media content, the loop playback times corresponding to the target media content, or the association relationship between the poster of the target media content and the first user.

Further, based on any one of the foregoing embodiments, the display module is further configured to: determine a page type corresponding to a media content playback page currently displayed; and in response to the playback information satisfying a display condition corresponding to the page type, display, in the media content playback page, the prompt information associated with the poster corresponding to the target media content.

Further, based on any one of the foregoing embodiments, the media content playback page is a first page type, a media content playback page of the first page type being used to play a recommended media content stream. The playback information comprises a playback progress corresponding to the target media content. The display module is further configured to: in response to detecting that the playback progress corresponding to the target media content exceeds a predetermined playback progress threshold, display, in the media content playback page, the prompt information associated with the poster corresponding to the target media content. The prompt information comprises amount of updated content posted by a poster within a first predetermined time interval.

Further, based on any one of the foregoing embodiments, the media content playback page is a second page type, a media content playback page of the second page type being used to play media content posted by at least one second user having a predetermined association relationship with the first user. The playback information comprises loop playback times corresponding to the target media content. The display module is further configured to: in response to detecting that the loop playback times corresponding to the target media content exceeds a predetermined playback times threshold, display, in the media content playback page, the prompt information associated with the poster corresponding to the target media content. The prompt information comprises amount of updated content posted by a poster within a second predetermined time interval.

Further, based on any one of the foregoing embodiments, the playback information comprises an association relationship between the poster of the target media content and the first user. The display module is further configured to: in response to detecting that the association relationship between the poster and the first user is any of at least one predetermined type of target association relationship, display, in the media content playback page, the prompt information associated with the poster corresponding to the target media content.

Further, based on any one of the foregoing embodiments, the display module is further configured to: in response to detecting that the association relationship between the poster and the first user is a predetermined first target association relationship, display, in the media content playback page, the prompt information associated with the poster corresponding to the target media content. The first target association relationship is used to represent that an accumulated duration of the first user watching media content posted by the poster exceeds a predetermined duration and/or an accumulated number of times of the first user watching media content posted by the poster exceeds a predetermined number of times. The prompt information comprises amount of updated content posted by a poster within a third predetermined time interval, and/or the prompt information comprises a prompt that the poster has updated content within a fourth predetermined time interval.

Further, based on any one of the foregoing embodiments, the display module is further configured to: in response to detecting that the association relationship between the poster and the first user is a predetermined second target association relationship, display a predetermined identification and/or a predetermined animation at an identification of the poster in the media content playback page. The second target association relationship is used to represent that the poster is a user for whom the first user sets the predetermined identification or the first user and the poster satisfy a predetermined association relationship with each other.

Further, based on any one of the foregoing embodiments, the display module is further configured to: display the prompt information at an association location corresponding to an identification of the poster in the media content playback page.

Further, based on any one of the foregoing embodiments, the apparatus further includes: a switch module, configured to in response to a triggering operation on the prompt information by the first user, switch to an updated content display page; and the display module is further configured to display, in the updated content display page, updated content posted by the poster within a predetermined time interval.

Further, based on any one of the foregoing embodiments, the switch module is further configured to: determine an association identification corresponding to the prompt information; and switch to an updated content display page corresponding to the association identification based on the association identification.

Further, based on any one of the foregoing embodiments, the updated content comprises updated media content or updated resource content.

Further, based on any one of the foregoing embodiments, the association identification comprises a type of the poster. The switch module is further configured to: in response to the type of the poster being a first type, switch to a first updated content display page based on the association identification, the first updated content display page being used to display updated media content posted by the poster within a predetermined time interval; and in response to the type of the poster being a second type, switch to a second updated content display page based on the association identification, the second updated content display page being used to display updated resource content posted by the poster within a predetermined time interval.

Further, based on any one of the foregoing embodiments, the association identification comprises an update type. The switch module is further configured to: in response to the update type being a media content update type, switching to a first updated content display page based on the association identification, the first updated content display page being used to display updated media content posted by the poster within a predetermined time interval; and in response to the update type being a resource content update type, switching to a second updated content display page based on the association identification, the second updated content display page being used to display updated resource content posted by the poster within a predetermined time interval.

Further, based on any one of the foregoing embodiments, the display module is further configured to: display, in the updated content display page, an updated content stream corresponding to updated content posted by the poster within the predetermined time interval.

The device provided by this embodiment may be configured to perform the technical solutions of the foregoing method embodiments, and its implementation principles and technical effects are similar, and details are not described here again in this embodiment.

An electronic device is also provided by another embodiment of the present disclosure, including: at least one processor and a memory.

The memory stores computer executable instructions.

The at least one processor executes the computer executable instruction stored in the memory, to causes the at least one processor to execute the method according to any one of the foregoing embodiments.

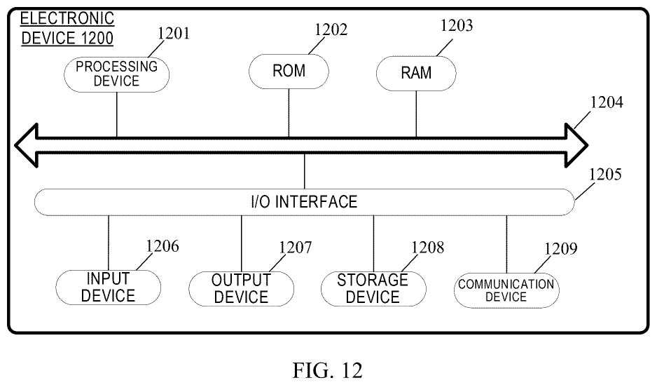

FIG. 12 is a schematic diagram of a structure of an electronic device provided by embodiments of the present disclosure. As shown in FIG. 12, the electronic device 1200 may be a terminal device or a server. The terminal device may include, but are not limited to, mobile phones, notebook computers, digital broadcast receivers, personal digital assistant (PDA), portable Android device (PAD), portable multimedia player (PMP), vehicle-mounted terminals (such as vehicle-mounted navigation terminals), etc., as well as fixed terminals such as digital television (TV), desktop computers, etc. The electronic device shown in FIG. 12 is only an example, and should not limit the function and application range of embodiments of the present disclosure.

As shown in FIG. 12, the electronic device 1200 may include a processing device (such as a central processing unit, a graphics processing unit, or the like) 1201 that may perform various appropriate actions and processing according to a program stored in a read only memory (ROM) 1202 or a program loaded from a storage device 1208 into a random access memory (RAM) 1203. In the RAM 1203, various programs and data required for operation of the electronic device 1200 are further stored. The processing device 1201, the ROM 1202, and the RAM 1203 are connected to each other by using a bus 1204. An input/output (I/O) interface 1205 is also connected to the bus 1204.

Generally, the following devices may be connected to the I/O interface 1205: input device 1206 including, for example, a touchscreen, a touchpad, a keyboard, a mouse, a camera, a microphone, an accelerometer, and a gyroscope; output device 1207 including, for example, a liquid crystal display (LCD), a loudspeaker and a vibrator; storage device 1208 including, for example, a tape or a hard disk; and a communication device 1209. The communication device 1209 may allow the electronic device 1200 to communicate wirelessly or wiredly with another device to exchange data. Although FIG. 12 shows an electronic device 1200 with various devices, it should be understood that it is not required to implement or provide all shown devices. Alternatively, more or fewer devices may be implemented or provided.

In particular, according to embodiments of the present disclosure, the process described above with reference to the flowchart may be implemented as a computer software program. For example, an embodiment of the present disclosure includes a computer software program product that includes a computer program carried on a computer readable medium, and the computer program includes program codes used to perform the methods shown in the flowchart. In such an embodiment, the computer program may be downloaded and installed from a network by using the communications device 1209, or installed from the storage device 1208, or installed from the ROM 1202. When the computer program is executed by the processing device 1201, the foregoing functions defined in the method in embodiments of the present disclosure are executed.

It should be noted that the foregoing computer-readable medium in the present disclosure may be a computer-readable signal medium, a computer-readable storage medium, or any combination of the two. The computer-readable storage medium may be, for example, an electrical, magnetic, optical, electromagnetic, infrared, or semiconductor system, apparatus, or means, or any combination thereof. More specific examples of the computer-readable storage medium may include but are not limited to: an electrical connection having one or more conducting wires, a portable computer disk, a hard disk, a random-access memory (RAM), a read-only memory (ROM), an erasable programmable read only memory (EPROM or flash memory), an optical fiber, a portable compact disk read only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or means. In addition, in the present disclosure, the computer-readable signal medium may include a data signal propagated in a baseband or as a part of a carrier, which carries computer-readable program codes. Such a propagated data signal may be in multiple forms, including but not limited to an electromagnetic signal, an optical signal, or any suitable combination thereof. The computer-readable signal medium may further be any computer-readable medium other than the computer-readable storage medium, and the computer-readable signal medium may send, propagate, or transmit a program that is used by or in combination with an instruction execution system, apparatus, or means. The program code included in the computer-readable medium may be transmitted by using any suitable medium, including but not limited to: a wire, an optical cable, radio frequency (RF), or any suitable combination thereof.

Another embodiment of the present disclosure further provides a computer readable storage medium, the computer readable storage medium storing computer executable instructions, when a processor executes the computer executable instructions, implements the method according to any of embodiments described above.

Another embodiment of the present disclosure further provides a computer program product, including computer executable instructions, when the computer executable instructions are executed by a processor, implements the method according to any of the foregoing embodiments.

Another embodiment of the present disclosure further provides a computer program, when executed by a processor, the computer program implements the method according to any of the foregoing embodiments.

The foregoing computer-readable medium may be included in the foregoing electronic device; it may also exist separately without being assembled into the electronic device.

The foregoing computer-readable medium carries one or more programs, when the foregoing one or more programs are executed by the electronic device, causing the electronic device to perform the method shown in the foregoing embodiments.

Computer program codes for performing the operations of the present disclosure may be written in one or more programming languages or a combination thereof, including object oriented programming languages, such as Java, Smalltalk, C++, and conventional procedural programming languages such as “C” or similar program design languages. The program codes may be executed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

The flowcharts and block diagrams in the accompanying drawings illustrate possible architectures, functions, and operations of systems, methods, and computer program products according to various embodiments of the present disclosure. In this regard, each block in a flowchart or block diagram may represent a module, program segment, or part of code that includes one or more executable instructions for implementing a specified logical function. It should also be noted that in some alternative implementations, functions marked in the block may also occur in different order than those marked in the accompanying drawings. For example, two blocks represented in succession may actually be executed in substantially parallel, and they may sometimes be executed in a reverse order, depending on the functions involved. It should also be noted that each block in the block diagram and/or flowchart and a combination of blocks in the block diagram and/or flowchart may be implemented by using a dedicated hardware-based system that performs a specified function or operation, or may be implemented by using a combination of dedicated hardware and a computer instruction.

The units involved in embodiments described in the present disclosure may be implemented either by means of software or by means of hardware. The names of these units do not limit the units themselves under certain circumstances, for example, the first obtaining unit may be further described as “a unit for obtaining at least two Internet Protocol addresses”.

The functions described above herein may be performed, at least in part, by one or more hardware logic components. For example, and without limitation, example types of hardware logic components that may be used include: Field Programmable Gate Arrays (FPGAs), Application Specific Integrated Circuits (ASICs), Application Specific Standard Product (ASSP), Systems on-a-chip (SOC), Complex Programmable Logical device (CPLD) and so on.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. Machine-readable media may include, but are not limited to, electronic, magnetic, optical, electromagnetic, infrared, or semiconductor systems, apparatus or device, or any suitable combination of the foregoing. More specific examples of machine-readable storage media would include one or more wire-based electrical connection, portable computer disks, hard disks, random access memory (RAM), read only memory (ROM), erasable programmable read only memory (EPROM or flash memory), optical fiber, portable compact disk read-only memory (CD-ROM), optical storage device, magnetic storage device, or any suitable combination of the foregoing content.

In a first aspect, a method of information display is provided according to one or more embodiments of the present disclosure, comprising:
playing target media content in a media content playback page, to determine playback information corresponding to the target media content; and in response to the playback information satisfying a predetermined display condition, displaying, in the media content playback page, prompt information associated with a poster corresponding to the target media content, the prompt information being used to prompt a first user that the poster posts updated content within a predetermined time interval.

According to one or more embodiments of the present disclosure, determining playback information corresponding to the target media content comprises:
determining at least one of: a playback progress corresponding to the target media content, loop playback times corresponding to the target media content, or an association relationship between the poster of the target media content and the first user;
obtaining the playback information based on at least one of: the playback progress corresponding to the target media content, the loop playback times corresponding to the target media content, or the association relationship between the poster of the target media content and the first user.

According to one or more embodiments of the present disclosure, in response to the playback information satisfying a predetermined display condition, displaying, in the media content playback page, prompt information associated with a poster corresponding to the target media content comprises: determining a page type corresponding to a media content playback page currently displayed; in response to the playback information satisfying a display condition corresponding to the page type, displaying, in the media content playback page, the prompt information associated with the poster corresponding to the target media content.

According to one or more embodiments of the present disclosure, the media content playback page is a first page type, a media content playback page of the first page type being used to play a recommended media content stream; and the playback information comprises a playback progress corresponding to the target media content;
in response to the playback information satisfying a display condition corresponding to the page type, displaying, in the media content playback page, the prompt information associated with the poster corresponding to the target media content comprises:
in response to detecting that the playback progress corresponding to the target media content exceeds a predetermined playback progress threshold, displaying, in the media content playback page, the prompt information associated with the poster corresponding to the target media content; wherein the prompt information comprises amount of updated content posted by a poster within a first predetermined time interval.

According to one or more embodiments of the present disclosure, the media content playback page is a second page type, a media content playback page of the second page type being used to play media content posted by at least one second user having a predetermined association relationship with the first user; and the playback information comprises loop playback times corresponding to the target media content;
in response to the playback information satisfying a display condition corresponding to the page type, displaying, in the media content playback page, the prompt information associated with the poster corresponding to the target media content comprises:
in response to detecting that the loop playback times corresponding to the target media content exceeds a predetermined playback times threshold, displaying, in the media content playback page, the prompt information associated with the poster corresponding to the target media content;
wherein the prompt information comprises amount of updated content posted by a poster within a second predetermined time interval.

According to one or more embodiments of the present disclosure, the playback information comprises an association relationship between the poster of the target media content and the first user;
in response to the playback information satisfying a predetermined display condition, displaying, in the media content playback page, prompt information associated with a poster corresponding to the target media content comprises:
in response to detecting that the association relationship between the poster and the first user is any of at least one predetermined type of target association relationship, displaying, in the media content playback page, the prompt information associated with the poster corresponding to the target media content.

According to one or more embodiments of the present disclosure, in response to detecting that the association relationship between the poster and the first user is any of at least one predetermined type of target association relationship, displaying, in the media content playback page, the prompt information associated with the poster corresponding to the target media content comprises:
in response to detecting that the association relationship between the poster and the first user is a predetermined first target association relationship, displaying, in the media content playback page, the prompt information associated with the poster corresponding to the target media content;
wherein the first target association relationship is used to represent that an accumulated duration of the first user watching media content posted by the poster exceeds a predetermined duration and/or an accumulated number of times of the first user watching media content posted by the poster exceeds a predetermined number of times; the prompt information comprises amount of updated content posted by a poster within a third predetermined time interval, and/or the prompt information comprises a prompt that the poster has updated content within a fourth predetermined time interval.

According to one or more embodiments of the present disclosure, in response to detecting that the association relationship between the poster and the first user is any of at least one predetermined type of target association relationship, displaying, in the media content playback page, the prompt information associated with the poster corresponding to the target media content comprises:
in response to detecting that the association relationship between the poster and the first user is a predetermined second target association relationship, displaying a predetermined identification and/or a predetermined animation at an identification of the poster in the media content playback page;
wherein the second target association relationship is used to represent that the poster is a user for whom the first user sets the predetermined identification or the first user and the poster satisfy a predetermined association relationship with each other.

According to one or more embodiments of the present disclosure, displaying, in the media content playback page, prompt information associated with a poster corresponding to the target media content comprises: displaying the prompt information at an association location corresponding to an identification of the poster in the media content playback page.

According to one or more embodiments of the present disclosure, after displaying prompt information associated with a poster corresponding to the target media content in the media content playback page, the method further comprises:
in response to a triggering operation on the prompt information by the first user, switching to an updated content display page;
displaying, in the updated content display page, updated content posted by the poster within a predetermined time interval.

According to one or more embodiments of the present disclosure, in response to a triggering operation on the prompt information by the first user, switching to an updated content display page comprises: determining an association identification corresponding to the prompt information;
jumping to an updated content display page corresponding to the association identification based on the association identification.

According to one or more embodiments of the present disclosure, the updated content comprises updated media content or updated resource content.

According to one or more embodiments of the present disclosure, the association identification comprises a type of the poster;
jumping to an updated content display page corresponding to the association identification based on the association identification comprises:
in response to the type of the poster being a first type, switching to a first updated content display page based on the association identification, the first updated content display page being used to display updated media content posted by the poster within a predetermined time interval;
in response to the type of the poster being a second type, switching to a second updated content display page based on the association identification, the second updated content display page being used to display updated resource content posted by the poster within a predetermined time interval.

According to one or more embodiments of the present disclosure, the association identification comprises an update type;
jumping to an updated content display page corresponding to the association identification based on the association identification comprises:
in response to the update type being a media content update type, switching to a first updated content display page based on the association identification, the first updated content display page being used to display updated media content posted by the poster within a predetermined time interval;
in response to the update type being a resource content update type, switching to a second updated content display page based on the association identification, the second updated content display page being used to display updated resource content posted by the poster within a predetermined time interval.

According to one or more embodiments of the present disclosure, displaying, in the updated content display page, updated content posted by the poster within a predetermined time interval comprises:
displaying, in the updated content display page, an updated content stream corresponding to updated content posted by the poster within the predetermined time interval.

In a second aspect, an apparatus for information display is provided according to one or more embodiments of the present disclosure, comprising:

A determination module configured to play target media content in a media content playback page, to determine playback information corresponding to the target media content;

A display module configured to in response to the playback information satisfying a predetermined display condition, display, in the media content playback page, prompt information associated with a poster corresponding to the target media content, the prompt information being used to prompt a first user that the poster posts updated content within a predetermined time interval.

According to one or more embodiments of the present disclosure, the determination module is further configured to:
determine at least one of: a playback progress corresponding to the target media content, loop playback times corresponding to the target media content, or an association relationship between the poster of the target media content and the first user;
obtain the playback information based on at least one of: the playback progress corresponding to the target media content, the loop playback times corresponding to the target media content, or the association relationship between the poster of the target media content and the first user.

According to one or more embodiments of the present disclosure, the display module is further configured to:
determine a page type corresponding to a media content playback page currently displayed;
in response to the playback information satisfying a display condition corresponding to the page type, display, in the media content playback page, the prompt information associated with the poster corresponding to the target media content.

According to one or more embodiments of the present disclosure, the media content playback page is a first page type, a media content playback page of the first page type being used to play a recommended media content stream; and the playback information comprises a playback progress corresponding to the target media content;
The display module is further configured to:
in response to detecting that the playback progress corresponding to the target media content exceeds a predetermined playback progress threshold, display, in the media content playback page, the prompt information associated with the poster corresponding to the target media content; wherein the prompt information comprises amount of updated content posted by a poster within a first predetermined time interval.

According to one or more embodiments of the present disclosure, the media content playback page is a second page type, a media content playback page of the second page type being used to play media content posted by at least one second user having a predetermined association relationship with the first user; and the playback information comprises loop playback times corresponding to the target media content;

The display module is further configured to:
in response to detecting that the loop playback times corresponding to the target media content exceeds a predetermined playback times threshold, display, in the media content playback page, the prompt information associated with the poster corresponding to the target media content;
wherein the prompt information comprises amount of updated content posted by a poster within a second predetermined time interval.

According to one or more embodiments of the present disclosure, the playback information comprises an association relationship between the poster of the target media content and the first user;

The display module is further configured to:
in response to detecting that the association relationship between the poster and the first user is any of at least one predetermined type of target association relationship, display, in the media content playback page, the prompt information associated with the poster corresponding to the target media content.

According to one or more embodiments of the present disclosure, the display module is further configured to:
in response to detecting that the association relationship between the poster and the first user is a predetermined first target association relationship, display, in the media content playback page, the prompt information associated with the poster corresponding to the target media content;
wherein the first target association relationship is used to represent that an accumulated duration of the first user watching media content posted by the poster exceeds a predetermined duration and/or an accumulated number of times of the first user watching media content posted by the poster exceeds a predetermined number of times; the prompt information comprises amount of updated content posted by a poster within a third predetermined time interval, and/or the prompt information comprises a prompt that the poster has updated content within a fourth predetermined time interval.

According to one or more embodiments of the present disclosure, the display module is further configured to:
in response to detecting that the association relationship between the poster and the first user is a predetermined second target association relationship, display a predetermined identification and/or a predetermined animation at an identification of the poster in the media content playback page;
wherein the second target association relationship is used to represent that the poster is a user for whom the first user sets the predetermined identification or the first user and the poster satisfy a predetermined association relationship with each other.

According to one or more embodiments of the present disclosure, the display module is further configured to:
display the prompt information at an association location corresponding to an identification of the poster in the media content playback page.

According to one or more embodiments of the present disclosure, the apparatus further comprises:
A switch module configured to in response to a triggering operation on the prompt information by the first user, switch to an updated content display page;
The display module is further configured to display, in the updated content display page, updated content posted by the poster within a predetermined time interval.

According to one or more embodiments of the present disclosure, the switch module is further configured to:
determine an association identification corresponding to the prompt information;
jump to an updated content display page corresponding to the association identification based on the association identification.

According to one or more embodiments of the present disclosure, the updated content comprises updated media content or updated resource content.

According to one or more embodiments of the present disclosure, the association identification comprises a type of the poster;
The switch module is further configured to:
in response to the type of the poster being a first type, switch to a first updated content display page based on the association identification, the first updated content display page being used to display updated media content posted by the poster within a predetermined time interval;
in response to the type of the poster being a second type, switch to a second updated content display page based on the association identification, the second updated content display page being used to display updated resource content posted by the poster within a predetermined time interval.

According to one or more embodiments of the present disclosure, the association identification comprises an update type.

The switch module is further configured to:
in response to the update type being a media content update type, switching to a first updated content display page based on the association identification, the first updated content display page being used to display updated media content posted by the poster within a predetermined time interval;
in response to the update type being a resource content update type, switching to a second updated content display page based on the association identification, the second updated content display page being used to display updated resource content posted by the poster within a predetermined time interval.

According to one or more embodiments of the present disclosure, the display module is further configured to:
display, in the updated content display page, an updated content stream corresponding to updated content posted by the poster within the predetermined time interval.

In a third aspect, an electronic device is provided according to one or more embodiments of the present disclosure, comprising: at least one processor and a memory;
the memory storing computer executable instructions;
the at least one processor executing the computer executable instructions stored in the memory, to cause the at least one processor to execute the method of information display according to the first aspect and various possible designs of the first aspect.

In a fourth aspect, a computer readable storage medium is provided according to one or more embodiments of the present disclosure, the computer readable storage medium storing computer executable instructions, when a processor executes the computer executable instructions, implements the method of information display according to the first aspect and various possible designs of the first aspect.

In a fifth aspect, a computer program product is provided according to one or more embodiments of the present disclosure, comprising computer executable instructions, when a processor executes the computer executable instructions, implements the method of information display according to the first aspect and various possible designs of the first aspect.

In a sixth aspect, a computer program is provided according to one or more embodiments of the present disclosure, when executed by a processor, the computer program implements the method of information display according to the first aspect and various possible designs of the first aspect.

The above description is only embodiments of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept, for example, a technical solution formed by interchanging the above features with (but not limited to) technical features with similar functions disclosed in the present disclosure.

Further, although the operations are depicted using a particular order, this should not be construed as requiring that the operations be performed in the particular order shown or in sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject has been described using language specific to structural features and/or method logical actions, it should be understood that the subject limited in the appended claims is not necessarily limited to the particular features or actions described above. Rather, the particular features and actions described above are merely example forms of implementing the claims.

1. A method of information display, comprising:
playing target media content in a media content playback page, to determine playback information corresponding to the target media content; and
in response to the playback information satisfying a predetermined display condition, displaying, in the media content playback page, prompt information associated with a poster corresponding to the target media content, the prompt information being configured to prompt a first user that the poster posts updated content within a predetermined time interval.

2. The method of claim 1, wherein determining the playback information corresponding to the target media content comprises:
determining at least one of: a playback progress corresponding to the target media content, loop playback times corresponding to the target media content, or an association relationship between the poster of the target media content and the first user; and
obtaining the playback information based on at least one of: the playback progress corresponding to the target media content, the loop playback times corresponding to the target media content, or the association relationship between the poster of the target media content and the first user.

3. The method of claim 1, wherein in response to the playback information satisfying a predetermined display condition, displaying, in the media content playback page, the prompt information associated with a poster corresponding to the target media content comprises:
determining a page type corresponding to a media content playback page currently displayed; and
in response to the playback information satisfying a display condition corresponding to the page type, displaying, in the media content playback page, the prompt information associated with the poster corresponding to the target media content.

4. The method of claim 3, wherein the media content playback page is of a first page type, a media content playback page of the first page type is configured to play a recommended media content stream; and the playback information comprises a playback progress corresponding to the target media content;
wherein in response to the playback information satisfying the display condition corresponding to the page type, displaying, in the media content playback page, the prompt information associated with the poster corresponding to the target media content comprises:
in response to the playback progress corresponding to the target media content exceeding a predetermined playback progress threshold, displaying, in the media content playback page, the prompt information associated with the poster corresponding to the target media content;
wherein the prompt information comprises amount of updated content posted by the poster within a first predetermined time interval.

5. The method of claim 3, wherein the media content playback page is of a second page type, a media content playback page of the second page type is configured to play media content posted by at least one second user having a predetermined association relationship with the first user; and the playback information comprises loop playback times corresponding to the target media content;
wherein in response to the playback information satisfying a-the display condition corresponding to the page type, displaying, in the media content playback page, the prompt information associated with the poster corresponding to the target media content comprises:
in response to the loop playback times corresponding to the target media content exceeding a predetermined playback times threshold, displaying, in the media content playback page, the prompt information associated with the poster corresponding to the target media content;
wherein the prompt information comprises amount of updated content posted by a-the poster within a second predetermined time interval.

6. The method of claim 1, wherein the playback information comprises an association relationship between the poster of the target media content and the first user;
wherein in response to the playback information satisfying the predetermined display condition, displaying, in the media content playback page, the prompt information associated with a the poster corresponding to the target media content comprises:
in response to the association relationship between the poster and the first user being any of at least one predetermined type of target association relationship, displaying, in the media content playback page, the prompt information associated with the poster corresponding to the target media content.

7. The method of claim 6, wherein in response to the association relationship between the poster and the first user being any of the at least one predetermined type of target association relationship, displaying, in the media content playback page, the prompt information associated with the poster corresponding to the target media content comprises:
in response to the association relationship between the poster and the first user being a predetermined first target association relationship, displaying, in the media content playback page, the prompt information associated with the poster corresponding to the target media content;
wherein the first target association relationship is configured to represent that an accumulated duration of the first user watching media content posted by the poster exceeds a predetermined duration and/or an accumulated number of times of the first user watching media content posted by the poster exceeds a predetermined number of times;
wherein the prompt information comprises amount of updated content posted by a poster within a third predetermined time interval, and/or the prompt information comprises a prompt that the poster has updated content within a fourth predetermined time interval.

8. The method of claim 6, wherein in response to the association relationship between the poster and the first user being any of the at least one predetermined type of target association relationship, displaying, in the media content playback page, the prompt information associated with the poster corresponding to the target media content comprises:
in response to the association relationship between the poster and the first user being a predetermined second target association relationship, displaying a predetermined identification and/or a predetermined animation at an identification of the poster in the media content playback page;
wherein the second target association relationship is configured to represent that the poster is a user for whom the first user sets the predetermined identification or the first user and the poster satisfy a predetermined association relationship with each other.

9. The method of claim 1, wherein displaying, in the media content playback page, the prompt information associated with the poster corresponding to the target media content comprises:
displaying the prompt information at an association location corresponding to an identification of the poster in the media content playback page.

10. The method of claim 1, wherein after displaying the prompt information associated with the poster corresponding to the target media content in the media content playback page, further comprising:
in response to a triggering operation on the prompt information by the first user, switching to an updated content display page; and
displaying, in the updated content display page, updated content posted by the poster within a predetermined time interval.

11. The method of claim 10, wherein in response to the triggering operation on the prompt information by the first user, switching to the updated content display page comprises:
determining an association identification corresponding to the prompt information; and jumping to the updated content display page corresponding to the association identification based on the association identification.

12. The method of claim 11, wherein the updated content comprises updated media content or updated resource content.

13. The method of claim 11, wherein the association identification comprises a type of the poster;
wherein switching to an the updated content display page corresponding to the association identification based on the association identification comprises:
in response to the type of the poster being a first type, switching to a first updated content display page based on the association identification, the first updated content display page being configured to display updated media content posted by the poster within a predetermined time interval; and
in response to the type of the poster being a second type, switching to a second updated content display page based on the association identification, the second updated content display page being configured to display updated resource content posted by the poster within a predetermined time interval.

14. The method of claim 11, wherein the association identification comprises an update type;
Wherein switching to the updated content display page corresponding to the association identification based on the association identification comprises:
in response to the update type being a media content update type, switching to a first updated content display page based on the association identification, the first updated content display page being configured to display updated media content posted by the poster within a predetermined time interval; and
in response to the update type being a resource content update type, switching to a second updated content display page based on the association identification, the second updated content display page being configured to display updated resource content posted by the poster within a predetermined time interval.

15. The method of claim 10, wherein displaying, in the updated content display page, the updated content posted by the poster within the predetermined time interval comprises:
displaying, in the updated content display page, an updated content stream corresponding to the updated content posted by the poster within the predetermined time interval.

16. (canceled)

17. An electronic device, comprising: at least one processor and a memory;
the memory storing computer executable instructions;
the at least one processor executing the computer executable instructions stored in the memory, to cause the at least one processor to perform at least:
playing target media content in a media content playback page, to determine playback information corresponding to the target media content; and
in response to the playback information satisfying a predetermined display condition, displaying, in the media content playback page, prompt information associated with a poster corresponding to the target media content, the prompt information being configured to prompt a first user that the poster posts updated content within a predetermined time interval.

18. A non-transitory computer readable storage medium, the computer readable storage medium storing computer executable instructions, when a processor executes the computer executable instructions, are configured to perform at least:
playing target media content in a media content playback page, to determine playback information corresponding to the target media content; and
in response to the playback information satisfying a predetermined display condition, displaying, in the media content playback page, prompt information associated with a poster corresponding to the target media content, the prompt information being configured to prompt a first user that the poster posts updated content within a predetermined time interval.

19. (canceled)

20. (canceled)

21. The electronic device of claim 17, wherein determining the playback information corresponding to the target media content comprises:
determining at least one of: a playback progress corresponding to the target media content, loop playback times corresponding to the target media content, or an association relationship between the poster of the target media content and the first user; and
obtaining the playback information based on at least one of: the playback progress corresponding to the target media content, the loop playback times corresponding to the target media content, or the association relationship between the poster of the target media content and the first user.

22. The electronic device of claim 17, wherein in response to the playback information satisfying a predetermined display condition, displaying, in the media content playback page, the prompt information associated with a poster corresponding to the target media content comprises:
determining a page type corresponding to a media content playback page currently displayed; and
in response to the playback information satisfying a display condition corresponding to the page type, displaying, in the media content playback page, the prompt information associated with the poster corresponding to the target media content.

23. The electronic device of claim 22, wherein the media content playback page is of a first page type, a media content playback page of the first page type is configured to play a recommended media content stream; and the playback information comprises a playback progress corresponding to the target media content;
wherein in response to the playback information satisfying the display condition corresponding to the page type, displaying, in the media content playback page, the prompt information associated with the poster corresponding to the target media content comprises:
in response to the playback progress corresponding to the target media content exceeding a predetermined playback progress threshold, displaying, in the media content playback page, the prompt information associated with the poster corresponding to the target media content;
wherein the prompt information comprises amount of updated content posted by the poster within a first predetermined time interval.
